(19) United States
(12) Patent Application Publication
(10) Pub. No.: US 2015/0112832 A1
(43) Pub. Date: Apr. 23, 2015

(54) EMPLOYING A PORTABLE COMPUTERIZED DEVICE TO ESTIMATE A TOTAL EXPENDITURE IN A RETAIL ENVIRONMENT

(71) Applicant: Wal-Mart Stores, Inc., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 14/061,542

(22) Filed: Oct. 23, 2013

(51) Int. Cl. G06Q 30/02; G06Q 30/06

(52) U.S. Cl. CPC G06Q 30/0283; G06Q 30/0633
USPC 705/26.8

(57) ABSTRACT

A computer-implemented process for determining a probable total expenditure for selected goods is described, and includes employing a portable computerized device to capture an image of a plurality of selected goods. An itemized list of probable selected products is generated based upon the image. A price is determined for each of the probable selected products, and a total probable expenditure for the itemized list of probable selected products is determined based upon the price for each of the probable selected products. The total probable expenditure is displayed on the portable computerized device.

### FIELD OF THE DISCLOSURE

The present disclosure relates generally to a retail environment, and in particular, examples of the present disclosure are related to employing a portable computerized device in the retail environment.

### BACKGROUND

Retail marketers offer goods for purchase by shoppers. Individual shoppers in a retail environment traverse aisles to peruse and select one or more items for purchase, which they may place in a shopping cart or otherwise convey to a checkout counter where the items are scanned or otherwise accounted for to determine a total price. A shopper may desire to have an estimate of a total expenditure for the items they are considering purchasing prior to proceeding to checkout.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 schematically shows schematically shows a shopping cart containing selected goods, and a portable computerized device configured with a camera that can be employed by an individual shopper in a retail environment, according to some embodiments of the present disclosure;

FIG. 2 schematically illustrates exemplary elements of the portable computerized device, according to some embodiments of the present disclosure;

FIG. 3 illustrates an exemplary portable computerized device embodied as a pair of glasses configured to project images upon a view of a wearer, according to some embodiments of the present disclosure;

FIG. 4 schematically shows an embodiment of the executable video analytical process, which is preferably executed in the remote processor to evaluate the compressed digital video file, according to some embodiments of the present disclosure;

FIG. 5 shows an exemplary itemized list including a total probable expenditure that can be displayed on the user interface of the portable computerized device, according to some embodiments of the present disclosure; and

FIG. 6 schematically illustrates exemplary elements of a remote server, according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or processes have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

By way of introduction, it is appreciated that a shopper engaged in retail shopping wants to a total expenditure for the items they are considering purchasing prior to proceeding to checkout at a retailer.

A computer-implemented process for determining a probable total expenditure for selected goods is described, and includes employing a portable computerized device to capture a digital video including images of a plurality of selected goods. An itemized list of probable selected products is generated based upon the images of the selected goods captured on the digital video. A price is determined for each of the probable selected products, and a total probable expenditure for the itemized list of probable selected products is determined based upon the price for each of the probable selected products. The total probable expenditure is displayed on the portable computerized device.

A detailed analysis of an entire shopping trip can be performed, for example, with detailed images being either analyzed within a portable computerized device of the customer or with a digital video feed being transmitted from the device to a remote server operated by the store, with the remote server analyzing the video feed. Either analysis can include image recognition processes or processes known in the art as computer vision to identify objects being purchased or placed in the cart of the customer for purchase. While a video feed of the entire shopping trip may be most efficient in accurately identifying or estimating objects placed in the cart, transmission of such a video feed or a plurality of customers simultaneously transmitting such video feeds can be prohibitive. Video feeds or digital video files can be quite large and require a large amount of digital bandwidth to transmit. According to one process, the bandwidth of such a transmission can be reduced by compressing the digital video file by processes known in the art. In another example, instead of capturing video of an entire shopping trip, the program can capture a video feed, analyze the video feed to identify when the customer interacts with a product, and then only transmit the portion of the video that includes the interaction with a product. In another example, the customer can be prompted to take a video or take digital images of the shopping cart either periodically or at the end of the shopping trip. In one example, the customer can be prompted to take video or images of the shopping cart from a number of different perspectives. In this way, items within the cart can be analyzed and identified or estimated based upon individual images or brief video files instead of by transmitting large or continuous video files.

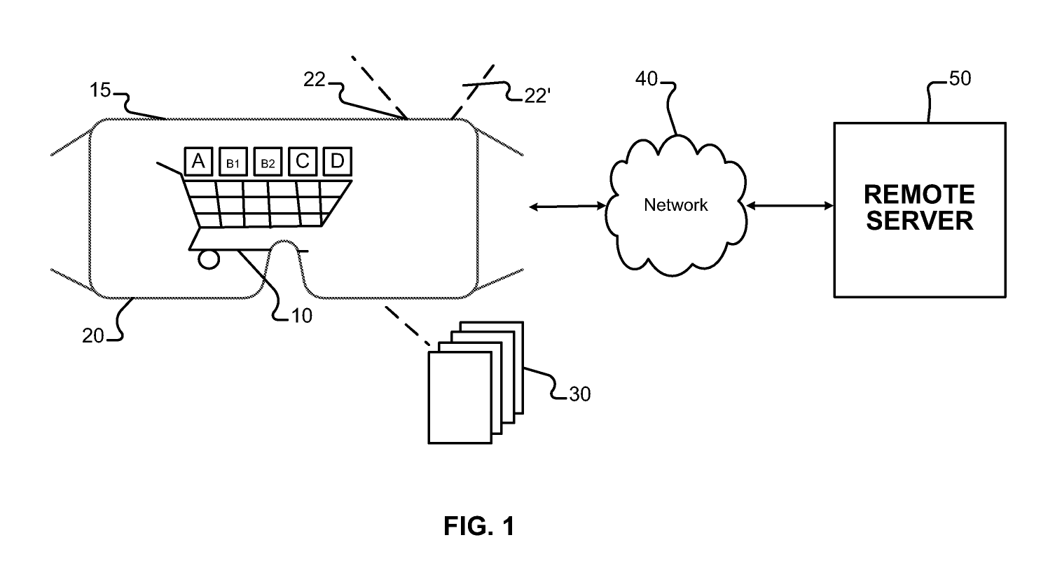

To illustrate, FIG. 1 schematically shows a portable computerized device 20 embodied as a pair of glasses configured to project images upon a view of the wearer. A shopping cart 10 containing selected goods 15 is visible through device 20. Portable computerized device 20 configured with a camera 22 that can be employed by an individual shopper in a retail environment to capture images of objects and actions taking place in the view of the shopper. A camera view 22′ is illustrated. The selected goods 15 are identified by letters A, B1, B2, C, and D to indicate different items, e.g., letters A, B, C, and D, and quantities of similar items, e.g., B1 and B2. During a shopping trip, an individual shopper employs the camera 22 to electronically capture a digital video 30 including a sequence of images of the selected goods 15 in the shopping cart 10. Digital video 30 can be compressed by processes known in the art. In the alternative to digital video 30, a single digital image or a series of non-sequential images can be captured and transmitted. Throughout the disclosure, a compressed digital video file will be disclosed as being transmitted and analyzed, but it is envisioned that any image or video format can be substituted for the video file.

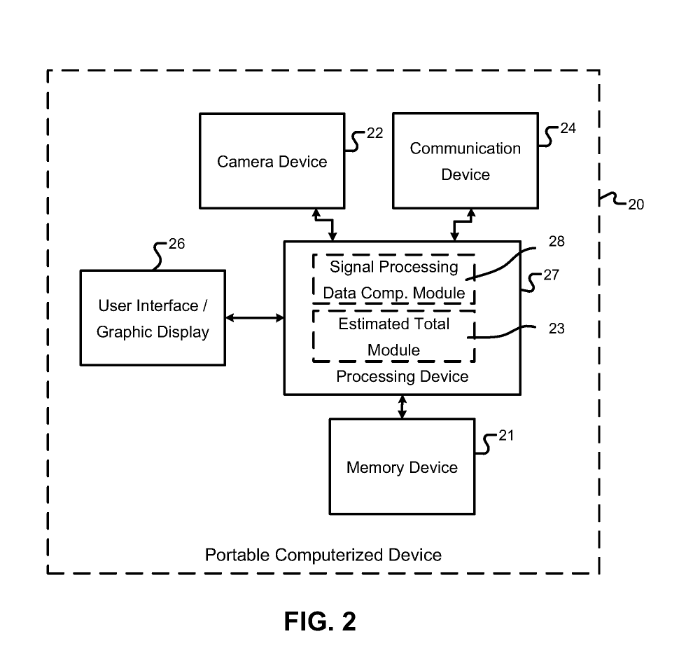

FIG. 2 schematically illustrates exemplary elements of the portable computerized device 20 of FIG. 1. In the illustrative embodiment, the portable computerized device 20 disclosed as a non-limiting example of a portable computerized device includes a processing device 27. Processing device 27 includes a processor and can execute programmable code. Processing device 27 includes process modules including signal processing and data compression module 28 and estimated total module 23. Device 20 further includes a user interface 26, communication device 24, a memory device 21, and a digital camera device 22. It is noted that the portable computerized device 20 can include other components and some of the components are not always required. Portable computerized device 20 can be operated by a customer for use in a process to permit a customer to estimate total expenditures prior to proceeding to checkout, as disclosed herein.

The processing device 27 can include memory, e.g., read only memory (ROM) and random access memory (RAM), storing processor-executable instructions and one or more processors that execute the processor-executable instructions. In embodiments where the processing device 27 includes two or more processors, the processors can operate in a parallel or distributed manner. The processing device 27 can execute the operating system of the portable computerized device 20. In the illustrative embodiment, the processing device 27 also executes data compression on captured files as described in greater detail below.

User interface 26 is a device that allows a user to interact with the portable computerized device 20. While one user interface 26 is shown, the term “user interface” can include, but is not limited to, a touch screen, a physical keyboard, a mouse, a microphone, and/or a speaker.

The communication device 24 is a device that allows the portable computerized device 20 to communicate with another device, e.g., a remote server 50, via a network 40. The communication device 24 can include one or more wireless transceivers for performing wireless communication and/or one or more communication ports for performing wired communication.

The camera 22 is a digital camera that captures digital images, including digital video. Camera 22 receives an instruction to video an image, captures a video of a location, e.g., goods contained in a shopping cart, and outputs a digital video file. The digital video file can be in the form of a bitmap file, an MPEG file, or any other suitably formatted file. The camera 22 can receive an instruction to capture a video image from the signal processing and data compression device 23 and can output the digital video thereto. Digital video is a type of digital recording that employs a digital camera to capture a series of frames that are digitized images of a field of view in rapid succession, preferably at a high rate of capture, e.g., 25-40 frames per second. The signal processing and data compression device 23 includes processes that perform data compression on a captured digital video file in preparation for communications and analysis.

The memory device 21 is a device that stores data generated or received by the portable computerized device 20. Memory device 21 can include, but is not limited to, a hard disc drive, an optical disc drive, and/or a flash memory drive.

Signal processing and data compression module 28 can include programming known in the art to process a series of images, compress the images into a compressed data stream, analyze the images for information, etc. Module 28 can be used to analyzed images captured by camera device 22 and either process the analysis data or pass the data along to server 50 for further analysis.

Estimated total module 23 communicates with remote server 50 and provides functionality related to estimating a total for goods placed in the shopping cart of the shopper, for example, by generating a display summarizing information provided by the remote server 50.

A portable computerized device can include any device capable of capturing an image, communicating with a remote server, and providing an output display to the customer. Non-limiting examples include the glasses of FIG. 1, a smart phone device, a tablet computer, and other similar devices known in the art.

Embodiments in accordance with the present disclosure may be embodied as an device, process, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.)

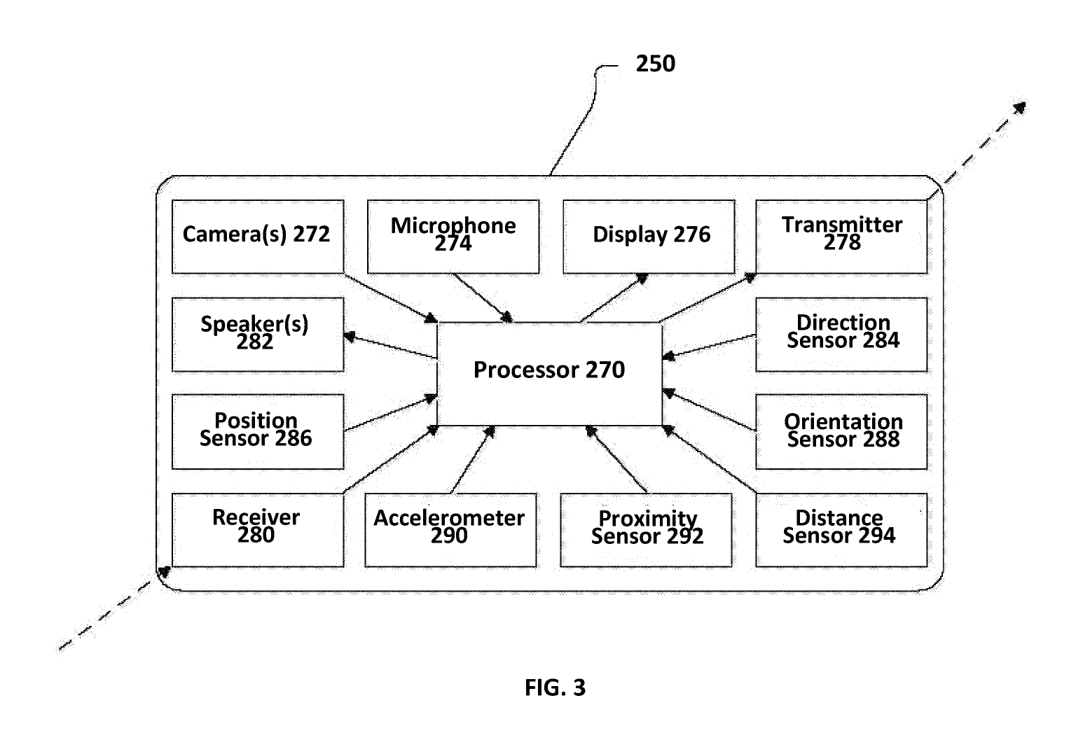

FIG. 3 is a block diagram illustrating exemplary components of a portable computerized device embodied as glasses configured to project images in a view of the wearer. Portable computerized device 250 can include exemplary eyeglasses attached to a head mount unit configured to display graphics in a view of a user. The portable computerized device can include a processor 270, one or more cameras 272, a microphone 274, a display 276, a transmitter 278, a receiver 280, one or more speakers 282, a direction sensor 284, a position sensor 286, an orientation sensor 288, an accelerometer 290, a proximity sensor 292, and a distance sensor 294.

The processor 270 can be operable to receive signals generated by the other components of the portable computerized device 250. The processor 270 can also be operable to control the other components of the portable computerized device 250. The processor 270 can also be operable to process signals received by a device configured as a head mount unit. While one processor 270 is illustrated, it should be appreciated that the term “processor” can include two or more processors that operate in an individual or distributed manner.

The a head mount unit can include one or more cameras 272. Each camera 272 can be configured to generate a video signal. One of the cameras 272 can be oriented to generate a video signal that corresponds to the field of view of the consumer wearing the head mount unit. Each camera 272 can be operable to capture single images and/or video and to generate a video signal based thereon. The video signal may be representative of the field of view of the consumer wearing the head mount unit.

In some embodiments of the disclosure, cameras 272 may be a plurality of forward-facing cameras 272. In such embodiments, the orientation of cameras 272 can be known and the respective video signals can be processed to triangulate an object with both video signals. This processing can be applied to determine the distance that the consumer is spaced from the object. Determining the distance that the consumer is spaced from the object can be executed by the processor 270 or by a remote server using known distance calculation processes.

Processing of the one or more, forward-facing video signals can also be applied to determine the identity of the object. Determining the identity of the object, such as the identity of a product in the retail store, can be executed by the processor 270 or by the remote server. If the processing is executed by the remote server, the processor 270 can modify the video signals to limit the transmission of data back to remote server. For example, the video signal can be parsed and one or more image files can be transmitted to the remote server instead of a live video feed. Further, the video can be modified from color to black and white to further reduce transmission load and/or ease the burden of processing for either the processor 270 or the remote server. Processor 270 can include process modules such as modules 23 and 28 of FIG. 2 in order to execute the processes disclosed herein.

In some embodiments of the present disclosure, the cameras 272 can include one or more inwardly-facing cameras directed toward the consumer's eyes. A video signal revealing the consumer's eyes can be processed using eye tracking processes to determine the direction that the consumer is viewing. In one example, a video signal from an inwardly-facing camera can be correlated with one or more forward-facing video signals to determine the object the consumer is viewing.

The microphone 274 can be configured to generate an audio signal that corresponds to sound generated by and/or proximate to the consumer. The audio signal can be processed by the processor 270 or by the remote server. For example, verbal signals can be processed by the remote server such as “this product appears interesting.” Such audio signals can be correlated to the video recording.

The display 276 can be positioned within the consumer's field of view. Video content can be shown to the consumer with the display 276. The display 282 can be configured to display text, graphics, images, illustrations and any other video signals to the consumer. The display 276 can be a transparent when not in use and partially transparent when in use to minimize the obstruction of the consumer's field of view through the display 276.

The transmitter 278 can be configured to transmit signals generated by the other components of the portable computerized device 250 from the head mount unit. The processor 270 can direct signals generated by components of the portable computerized device 250 to the commerce sever through the transmitter 278. The transmitter 278 can be an electrical communication element within the processor 270. In one example, the processor 270 is operable to direct the video and audio signals to the transmitter 278 and the transmitter 278 is operable to transmit the video signal and/or audio signal from the head mount unit, such as to the remote server through a communications network.

The receiver 280 can be configured to receive signals and direct signals that are received to the processor 270 for further processing. The receiver 280 can be operable to receive transmissions from the network and then communicate the transmissions to the processor 270. The receiver 280 can be an electrical communication element within the processor 270. In some embodiments of the present disclosure, the receiver 280 and the transmitter 278 can be an integral unit.

The transmitter 278 and receiver 280 can communicate over a Wi-Fi network, allowing the head mount device to exchange data wirelessly (using radio waves) over a computer network, including high-speed Internet connections. The transmitter 278 and receiver 280 can also apply Bluetooth® standards for exchanging data over short distances by using short-wavelength radio transmissions, and thus creating personal area network (PAN). The transmitter 278 and receiver 280 can also apply 3G or 4G, which is defined by the International Mobile Telecommunications-2000 (IMT-2000) specifications promulgated by the International Telecommunication Union.

The head mount unit can include one or more speakers 282. Each speaker 282 can be configured to emit sounds, messages, information, and any other audio signal to the consumer. The speaker 282 can be positioned within the consumer's range of hearing. Audio content transmitted by the remote server can be played for the consumer through the speaker 282. The receiver 280 can receive the audio signal from the remote server and direct the audio signal to the processor 270. The processor 270 can then control the speaker 282 to emit the audio content.

The direction sensor 284 can be configured to generate a direction signal that is indicative of the direction that the consumer is facing. The direction signal can be processed by the processor 270 or by the remote server. For example, the direction sensor 284 can electrically communicate the direction signal containing direction data to the processor 270 and the processor 270 can control the transmitter 278 to transmit the direction signal to the remote server through the network. By way of example and not limitation, the direction signal can be useful in determining the identity of a product(s) visible in the video signal, as well as the location of the consumer within the retail store.

The direction sensor 284 can include a compass or another structure for deriving direction data. For example, the direction sensor 284 can include one or more Hall effect sensors. A Hall effect sensor is a transducer that varies its output voltage in response to a magnetic field. For example, the sensor operates as an analog transducer, directly returning a voltage. With a known magnetic field, its distance from the Hall plate can be determined. Using a group of sensors disposing about a periphery of a rotatable magnetic needle, the relative position of one end of the needle about the periphery can be deduced. It is noted that Hall effect sensors can be applied in other sensors of the head mountable unit.

The position sensor 286 can be configured to generate a position signal indicative of the position of the consumer within the retail store. The position sensor 286 can be configured to detect an absolute or relative position of the consumer wearing the head mountable unit. The position sensor 286 can electrically communicate a position signal containing position data to the processor 270 and the processor 270 can control the transmitter 278 to transmit the position signal to the remote server through the network.

Identifying the position of the consumer can be accomplished by radio, ultrasound or ultrasonic, infrared, or any combination thereof. The position sensor 286 can be a component of a real-time locating system (RTLS), which is used to identify the location of objects and people in real time within a building such as a retail store. The position sensor 286 can include a tag that communicates with fixed reference points in the retail store. The fixed reference points can receive wireless signals from the position sensor 286. The position signal can be processed to assist in determining one or more products that are proximate to the consumer and are visible in the video signal.

The orientation sensor 288 can be configured to generate an orientation signal indicative of the orientation of the consumer's head, such as the extent to which the consumer is looking downward, upward, or parallel to the ground. A gyroscope can be a component of the orientation sensor 288. The orientation sensor 288 can generate the orientation signal in response to the orientation that is detected and communicate the orientation signal to the processor 270. The orientation of the consumer's head can indicate whether the consumer is viewing a lower shelf, an upper shelf, or a middle shelf

The accelerometer 290 can be configured to generate an acceleration signal indicative of the motion of the consumer. The acceleration signal can be processed to assist in determining if the consumer has slowed or stopped, tending to indicate that the consumer is evaluating one or more products for purchase. The accelerometer 290 can be a sensor that is operable to detect the motion of the consumer wearing the head mountable unit. The accelerometer 290 can generate a signal based on the movement that is detected and communicate the signal to the processor 270. The motion that is detected can be the acceleration of the consumer and the processor 270 can derive the velocity of the consumer from the acceleration. Alternatively, the remote server can process the acceleration signal to derive the velocity and acceleration of the consumer in the retail store.

The proximity sensor 292 can be operable to detect the presence of nearby objects without any physical contact. The proximity sensor 292 can apply an electromagnetic field or a beam of electromagnetic radiation such infrared and assess changes in the field or in the return signal. Alternatively, the proximity sensor 292 can apply capacitive photoelectric principles or induction. The proximity sensor 292 can generate a proximity signal and communicate the proximity signal to the processor 270. The proximity sensor 292 can be useful in determining when a consumer has grasped and is inspecting a product.

The distance sensor 294 can be operable to detect a distance between an object and the head mount unit. The distance sensor 294 can generate a distance signal and communicate the signal to the processor 270. The distance sensor 294 can apply a laser to determine distance. The direction of the laser can be aligned with the direction that the consumer is facing. The distance signal can be useful in determining the distance to an object in the video signal generated by one of the cameras 272, which can be useful in determining the consumer's location in the retail store.

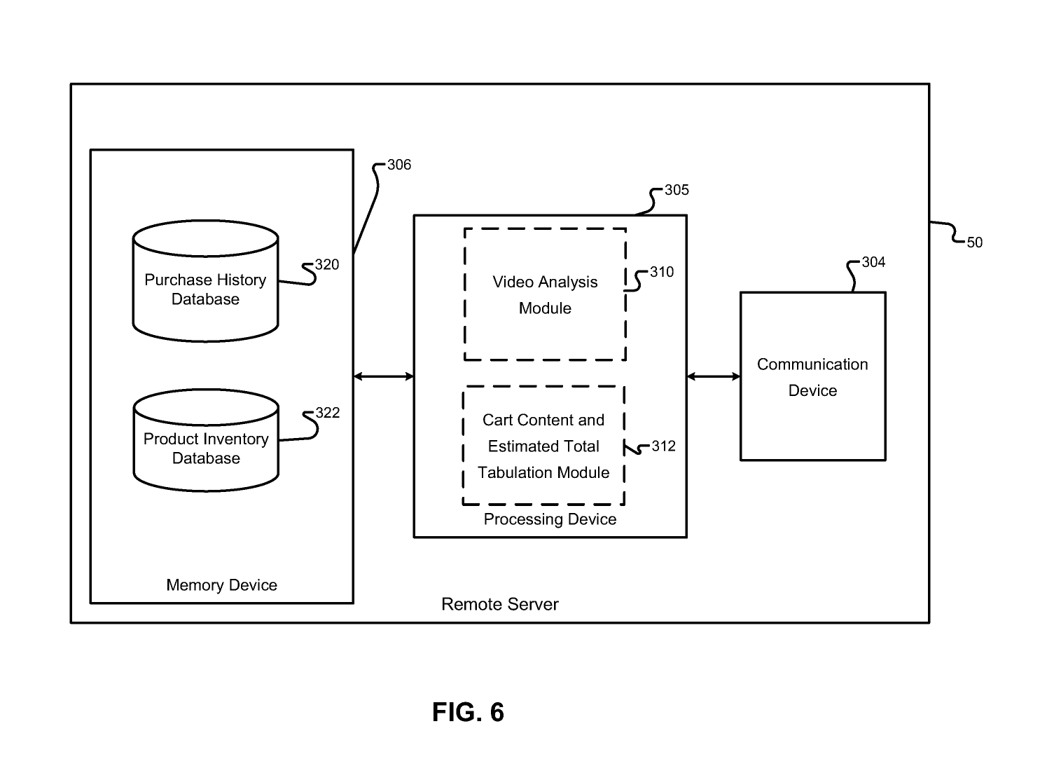

Referring now to FIG. 6, a block diagram illustrating an exemplary remote server 50 is depicted. In an exemplary embodiment, the remote server 50 embodied as a customer service server includes a processing device 305, a communication device 304, and memory device 306.

The processing device 305 can include memory, e.g., read only memory (ROM) and random access memory (RAM), storing processor-executable instructions and one or more processors that execute the processor-executable instructions. In embodiments where the processing device 305 includes two or more processors, the processors can operate in a parallel or distributed manner. In the illustrative embodiment, the processing device 305 executes a video analysis module 310 and a cart content and estimated total tabulation module 312, which are described in greater detail below.

The communication device 304 is a device that allows the remote server 50 to communicate with another device, e.g., a portable computerized device, via the network 40. The communication device 304 can include one or more wireless transceivers for performing wireless communication and/or one or more communication ports for performing wired communication.

The memory device 306 is a device that stores data generated or received by the remote server 50. The memory device 306 can include, but is not limited to a hard disc drive, an optical disc drive, and/or a flash memory drive. The memory device 306 is accessible to the processing device 305. A product inventory database 322 can be stored in the memory device, for example, providing a list of products offered at a particular store, prices for products in the store, return and exchange policies for particular items in the store, etc. Product inventory database 322 can further include information related to packaging, logos, and other information that can be determined and compared through analysis of compressed video file 30′. Product inventory database 322 can further include information about where in a particular store an item is presented on the shelves. If a customer has placed an item in a cart that could either be a breakfast cereal or a pasta mix, a location of the shopper at the time and information from the database describing where in the store such an item can be acquired can help to accurately estimate which product was just placed in the cart. A purchase history database 320 can be also stored in the memory device 306. Database 320 can include information related to a purchase history of the customer, purchase histories of groups of shippers, and purchasing patterns such as likely groupings of products that tend to be acquired in a particular sequence, wherein such histories and pattern information can be used to estimate or make guesses regarding likelihoods regarding the shopper and what is likely to be in the present shopping cart.

The video analysis module 310 receives compressed video file 30′ and applies signal processing, pattern recognition software, machine learning algorithms, and other processes known in the art to identify or estimate likely products that are acquired by the shopper and placed in the cart. Packaging, logos, locations of the shopper within the store, barcodes or fragments of barcodes, or other information can be used to estimate an identity of an acquired object. Customer preferences can be programmed, for example, with module 310 simply making the best of information made available through video file 30′ or permitting some inquiry by the device of the shopper, for example, completing partial information by asking whether the shopper selected the small or the large container of orange juice.

Cart content and estimated total module 312 receives information from module 310 and builds a list of objects likely to be in the cart. Module 312 generates an itemized list of probable products and quantities. Module 312 further accesses database 322 to assign prices to the itemized list and sum an estimated total expenditure for the list.

Modules 310 and 312 can apply programming to calculate likelihoods and probabilities according to processes known in the art, for example, estimating based upon available information an identity of particular item, a quantity likely put in the cart, and other similar information required to generate an itemized list of items probably within the cart.

It is appreciated that the foregoing example of the remote server 50 is not intended to be limiting. Variations of the exemplary remote server 50 are contemplated and within the scope of the disclosure. Functions disclosed to be operated within remote server 50 can be distributed to the portable computerized device and still remain within the scope of the disclosure and vice versa.

The remote server 50 includes a processing device, a communication device, and memory device that preferably includes a file including a store inventory. The processing device of the remote server 50 can include memory, e.g., read only memory (ROM) and random access memory (RAM), storing processor-executable instructions and one or more processors that execute the processor-executable instructions. In embodiments including two or more processors, the processors can operate in a parallel or distributed manner. In the illustrative embodiment, the processing device executes video analytical process 100. The communication device of the remote server 50 is a device that allows the server to communicate with another device, e.g., the portable computerized device. The communication device can include one or more wireless transceivers for performing wireless communication and/or one or more communication ports for performing wired communication.

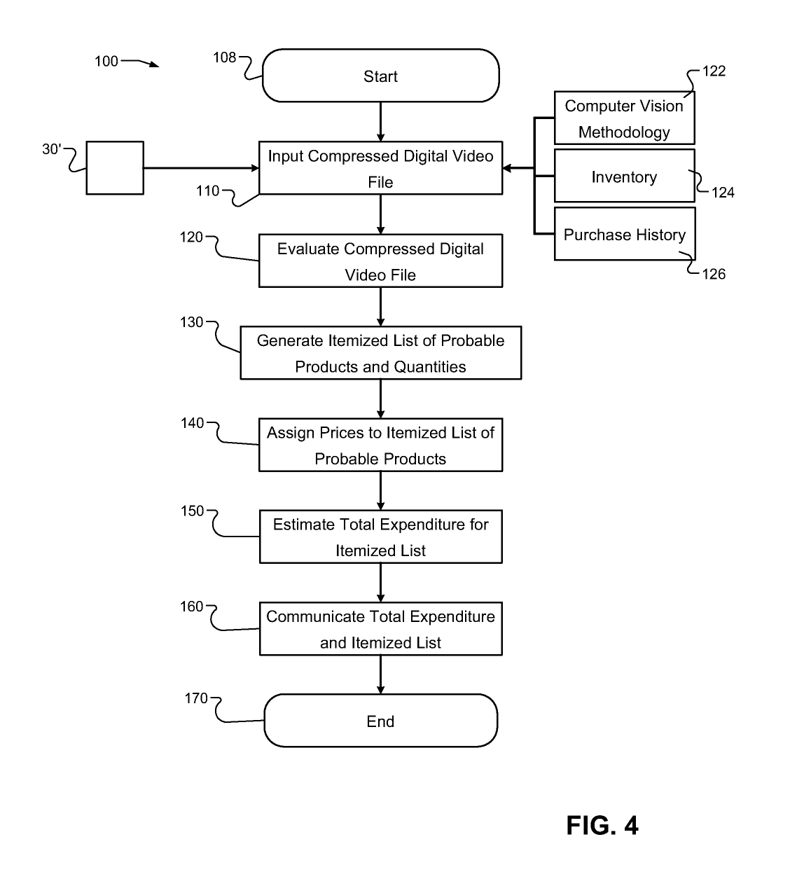

FIG. 4 schematically shows an embodiment of the executable video analytical process 100, which is preferably executed in the remote processor 50 to evaluate a compressed digital video file 30′ to generate an itemized list of probable selected products correlated with the images of the selected goods 15 in the shopping cart 10 and generate an estimate of a total expenditure for the itemized list. The total expenditure is communicated to the portable computerized device 20 for review by the customer.

In operation, the video analytical process 100 receives the compressed digital video file 30′ communicated from a remote portable computerized device (110) for evaluation (120). Evaluating the compressed digital video file 30′ includes employing computer vision processologies (122) in combination with store inventory product image files (124) and customer purchase history (126) to analyze the compressed digital video 30′ to effect object recognition that correlates probable products offered for sale by the retailer with images of the selected goods 15 in the shopping cart 10. Computer vision includes processes for acquiring, processing, analyzing, and understanding digital images and high-dimensional data to recognize objects. Object recognition includes employing mathematical models constructed with the aid of geometry, physics, statistics, and learning theory to separate, distinguish, compare and identify objects contained in the compressed digital video file 30′ using a known finite quantity of products, such as is contained in the store inventory product image files (124) in conjunction with a customer purchase history that is associated with the specific portable computerized device 20 that has communicated the compressed digital video file 30′ to the remote server 50 (126). An itemized list of probable products and associated quantities of those products is generated (130) based upon the evaluation (120). The remote server employs the in-store inventory to assign prices to the itemized list of probable products and associated quantities (140) and estimates a total probable expenditure for the itemized list of probable products and associated quantities (150). The remote server 50 communicates the total probable expenditure and the itemized list of probable products and associated quantities to the specific portable computerized device 20 that communicated the compressed digital video file 30′, which can be reviewed by the customer prior to checkout.

The flowchart and block diagrams in the flow diagrams illustrate the architecture, functionality, and operation of possible implementations of systems, processes, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing device to function in a particular manner, such that the instructions stored in the computer-readable medium produce an article of manufacture including instruction means which implement the function/act specified in the flowchart and/or block diagram block or blocks.

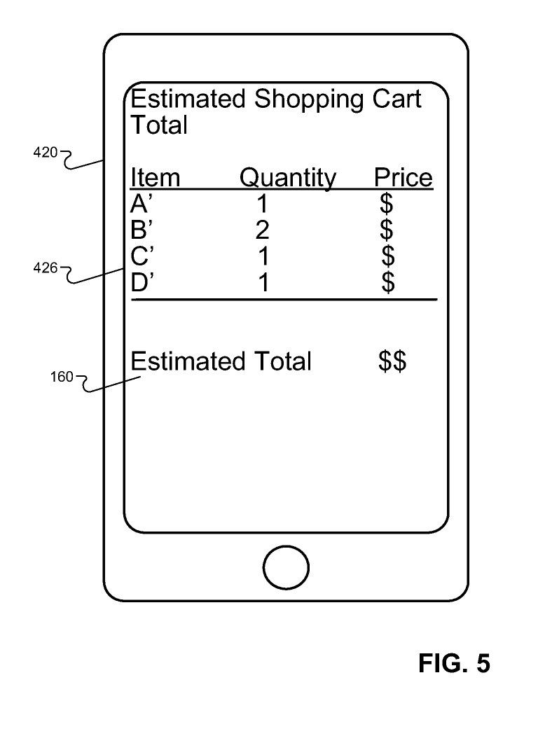

FIG. 5 shows an exemplary itemized list 160 including a total probable expenditure that can be displayed on the user interface 426 of a portable computerized device 420 embodied as a smart phone device. As shown the items depicted on the itemized list include items A′, B′, C′, and D′, indicating that the items are only probable items, and may not exactly match the items A, B, C, and D contained in the customer's shopping cart 10 and shown with reference to FIG. 1.

The above description of illustrated examples of the present disclosure, including what is described in the Abstract, are not intended to be exhaustive or to be limitation to the precise forms disclosed. While specific embodiments of, and examples for, the disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A computerized process for determining a probable total expenditure for selected goods, the process comprising:
employing a portable computerized device to capture an image of a plurality of selected goods;
within a computerized processor:
generating an itemized list of probable selected products based upon the image;
determining a price for each of the probable selected products,
determining a total probable expenditure for the itemized list of probable selected products based upon the price for each of the probable selected products; and
displaying the total probable expenditure on the portable computerized device.

2. The computerized process of claim 1, further comprising employing the portable computerized device to capture a plurality of images of the plurality of selected goods; and
wherein generating the itemized list of probable selected products is based upon the plurality of images.

3. The computerized process of claim 1, further comprising employing the portable computerized device to capture a plurality of images of the plurality of selected goods, the plurality of images comprising a compressed digital video file; and
wherein generating the itemized list of probable selected products is based upon the compressed digital video file.

4. The computerized process of claim 1, further comprising:
employing the portable computerized device to capture a plurality of images of the plurality of selected goods, the plurality of images comprising a video feed; and
compressing the video feed to create a compressed digital video file; and
wherein generating the itemized list comprises:
communicating the compressed digital video file to a remote server; and
within said remote server, analyzing the compressed digital video file to generate the itemized list.

5. The computerized process of claim 4, wherein analyzing the compressed digital video file to generate the itemized list of probable selected products comprises employing computer vision to evaluate the compressed digital video file to identify individual probable selected products.

6. The computerized process of claim 5, wherein employing computer vision comprises employing the computer vision to correlate images of selected goods captured on the compressed digital video file with known products contained in store inventory.

7. The computerized process of claim 5, wherein employing computer comprises employing the computer vision to correlate images of selected goods captured on the compressed digital video file with known products contained in store inventory and a customer purchase history.

8. The computerized process of claim 1, further comprising displaying the itemized list on the portable computerized device.

9. The computerized process of claim 1, further comprising:
employing the portable computerized device to capture a plurality of images of the plurality of selected goods, the plurality of images comprising a video feed; and
compressing the video feed to create a compressed digital video file; and
wherein generating the itemized list comprises:
communicating the compressed digital video file to a remote server; and
within said remote server, analyzing the compressed digital video file to generate the itemized list, said analyzing comprising utilizing computer vision to compare identified items in the compressed digital video file to known products contained in store inventory.

10. The computerized process of claim 1, further comprising:
employing the portable computerized device to capture a plurality of images of the plurality of selected goods, the plurality of images comprising a video feed; and
compressing the video feed to create a compressed digital video file; and
wherein generating the itemized list comprises:
communicating the compressed digital video file to a remote server; and
within said remote server, analyzing the compressed digital video file to generate the itemized list, said analyzing comprising utilizing computer vision to compare identified items in the compressed digital video file to known products contained in a customer purchase history.

11. A software application executed on a remote server for determining a probable total expenditure for selected goods, the application comprising:
generating an itemized list of probable selected products based upon a plurality of images of selected goods captured within a compressed digital video file, said compressed digital video file comprising images of a plurality of selected goods captured, compressed and communicated from a portable computerized device;
determining a price for each of the probable selected products,
determining a total probable expenditure for the itemized list of probable selected products based upon the price for each of the probable selected products; and
communicating the total probable expenditure to the portable computerized device.

12. The software application of claim 11, wherein generating the itemized list comprises utilizing image recognition to analyze the compressed digital video file and generating the itemized list based upon the analyzing.

13. The software application of claim 12, wherein utilizing image recognition comprises employing the image recognition to correlate goods captured on the compressed digital video file with known products contained in store inventory.

14. The software application of claim 12, wherein utilizing image recognition comprises employing the image recognition to correlate goods captured on the compressed digital video file with known products contained in a customer purchase history.

15. The software application of claim 12, wherein utilizing image recognition comprises employing the image recognition to correlate goods captured on the compressed digital video file with known products contained in store inventory and with known products contained in a customer purchase history.

16. The software application of claim 11, further comprising communicating the itemized list of products to the portable computerized device.

17. A software application executed on a portable computerized device for determining a probable total expenditure for selected goods in a retail store, the application comprising:
in the portable computerized device, prompting a customer using the portable computerized device to capture an image of the selected goods;
analyzing with computer vision the image of the selected goods, wherein the analyzing is used to generate an itemized list of probable selected products based upon the analysis;
determining a price for each of the probable selected products, determining a total probable expenditure for the itemized list of probable selected products based upon the price for each of the probable selected products; and
displaying the total probable expenditure upon the portable computerized device.

18. The software application of claim 17, wherein analyzing with computer vision the image of the selected goods comprises:
transmitting the image to a remote server; and
receiving the itemized list from the remote server.
